(19) United States
(12) Patent Application Publication
(10) Pub. No.: US 2008/0087054 A1
(43) Pub. Date: Apr. 17, 2008

(54) Single-point locking device

(75) Inventor: Rainer Hoffmann, Langenfeld (DE)

Correspondence Address: ROBERT W. BECKER & ASSOCIATES, 707 HIGHWAY 333, SUITE B, TIJERAS, NM, 87059-7507, US

(73) Assignee: EMKA Beschlagteile GmbH & Co. KG, Velbert (DE)

(21) Appl. No.: 11/904,770

(22) Filed: Sep. 28, 2007

(30) Foreign Application Priority Data
Sep. 30, 2006 (DE) 20 2006 015 093.5

(51) Int. Cl. E05B 65/44

(52) U.S. Cl. 70/101

(57) ABSTRACT

A locking device, especially for switch cabinets, comprising a lock mounted on the cabinet body and provided with a locking latch, as well as a lock holder mounted on the door and having an arresting pin for latching with the locking latch, whereby the rotatably mounted locking latch is biased by a tipping spring not only in its locking position in which it engages the arresting pin but also in its opening position, and whereby a rotatable securing lever for blocking pivoting movement of the locking latch is biased by a spring into its blocking position for the locking latch, the securing lever being pivotable, against the force of the spring, into its release position for the locking latch by an electromagnet through which current flows for providing a readiness of the locking latch to open.

The instant application should be granted the priority date of 30 Sep. 2006, the filing date of the corresponding German patent application DE 20 2006 015 093.5

### BACKGROUND OF THE INVENTION

The present invention relates to a locking device, especially for switch cabinets, in the form of a single-point latching or locking mechanism.

Such single-point mechanisms are known in the form of so-called casement or rotary locks or latches, as described, for example, in DE 298 06 963. In this connection, mounted on the door is a locking device having a rotatable tongue disposed thereon that engages behind a portion of the cabinet body and thereby locks the door with the body of the cabinet. Such a device has the drawback that it respectively requires an actuation of the casement lock by means of a key or via some other actuation in order to rotate the tongue into its opening or locking position and thus to be able to open the door or to keep it closed. Such an actuation is not desired for all applications.

It is an object of the present invention to provide a single-point latching or locking mechanism with which the closing and opening of the door is effected by a simple pressure or pulling upon the door, whereby at the same time if necessary a reliable locking or latching is to be provided for the door.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective, exploded view showing the individual components of a locking device;

FIG. 2 is an assembled view of the locking device of FIG. 1 in the opening position of its locking latch;

FIG. 3 shows the locking device of FIG. 2 in the locking position with the locking latch locked; and

FIG. 4 shows the locking device of FIG. 2 or FIG. 3 in the locking position with the locking latch in the ready to open position.

### SUMMARY OF THE INVENTION

The locking device of the present application comprises a lock that is to be mounted on the cabinet body and is provided with a locking latch, and also comprises a lock holder that is to be mounted on the door and that has an arresting pin for latching with the locking latch, whereby the pivotably mounted locking latch is biased by a tipping spring not only in its locking position, in which it engages the arresting pin, but also in its opening position, and whereby a pivotable securing lever, for blocking a pivoting movement of the locking latch, is biased by a spring into a position in which it blocks the locking latch, the securing lever being pivotable, into its release position for the locking latch, against the force of the spring by an electromagnet through which current flows for providing a readiness of the locking latch to open.

To the extent that a lock holder having an arresting pin disposed thereon is mounted on the door, for the closing or opening of the door it is merely necessary to bring the door, or the arresting pin carried by the lock holder, into or out of engagement with the locking latch of the lock secured to the body of the cabinet. Since the locking latch is biased into its two functional positions, in other words the locking position and the opening position, in both cases by a tipping spring that effects an arresting function of the locking latch, there results an automatic holding effect of the locking device not only in the closed position of the door but also in the opening position of the locking latch, so that the door can easily be closed by introducing the arresting pin into the locking latch, which is held in the opening position. The locking latch is respectively secured in its closing position by a spring-biased securing lever, so that the door cannot be pulled open, yet by means of an electromagnet through which current flows the securing lever can be kept out of engagement with the locking latch, thus providing a readiness of the locking latch to open, so that opening of the door by pulling on the door, accompanied by the overcoming of the force of the tipping spring that is connected therewith, can be undertaken.

Pursuant to one embodiment of the present invention a microswitch, associated with the locking latch for generating a signal, can be disposed in the lock. This has the advantage that the position of the locking latch can be scanned by a signal, such as, for example, the lighting-up of a lamp. Thus, the respective position of the locking latch in its opening position as well as in its locking position can be indicated, so that it is possible to determine from outside the cabinet whether the door can be closed by pressing on it, since the locking latch is in its opening position, or whether the door is closed and the locking latch is in the locking position.

Pursuant to one exemplary embodiment of the invention, for this purpose the microswitch can be actuated by the locking latch in its opening position. There thus also exists at the same time the possibility of giving off a signal for the indication of the locking position of the locking latch.

With regard to the securement of the locking latch in its locking position, pursuant to one embodiment of the invention the securing lever, in its blocking position, can rest against a shoulder disposed on the outer surface of the locking latch.

With respect to an easy operation and functioning of the locking device, pursuant to one embodiment of the invention the inner surfaces of the receiving opening formed in the locking latch for cooperating with the arresting pin are embodied in such a way that via pressure exerted upon the lock holder by the arresting pin, the pivoting of the locking latch into its locking position is effected, and by pulling exerted upon the lock holder by the arresting pin the pivoting of the locking latch into its opening position is effected.

Further specific features and advantages of the present invention will be described in detail subsequently.

### DESCRIPTION OF SPECIFIC EMBODIMENTS

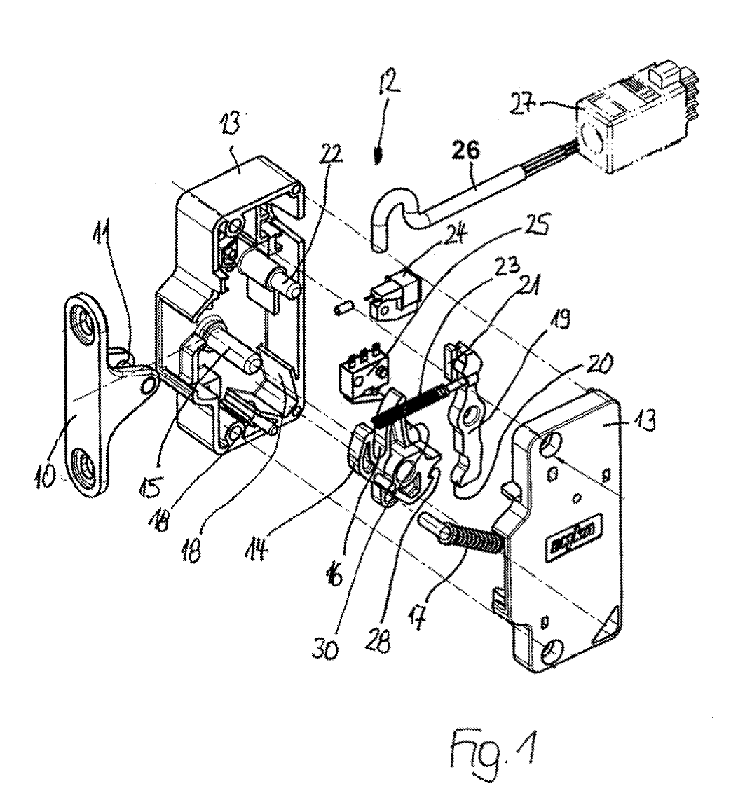

Referring now to the drawings in detail, the locking device shown in FIG. 1 first of all comprises a lock holder 10 which is to be mounted on a non-illustrated door of, in particular, a switch cabinet; the lock holder 10 has an arresting pin 11.

A lock 12 can be secured to the similarly non-illustrated body of the pertaining switch cabinet; the lock 12 is comprised of two housing sections 13. A locking latch 14 is disposed in the interior of the housing so as to be rotatable about a pivot pin 15 that is fixed to the housing; the locking latch 14 is provided with a receiving opening 16 for the arresting pin 11. The locking latch 14 is disposed in the housing 13 in such a way that in the opening position of the locking latch, which will be explained in greater detail subsequently, the arresting pin 11 of the lock holder 10 can be introduced into the receiving opening 16 of the locking latch 14, while in the locking position the locking latch 14 securely holds the arresting pin 11 in its receiving opening 16. For this purpose, the locking latch 14 is acted upon by a tipping spring 17 that biases the locking latch 14 not only in its opening position but also in its locking position, and in so doing passes through a dead position. In both of the end positions, the tipping spring 17 is held by housing abutments 18 in a defined position. Due to the biasing by means of the tipping spring 17, a latching or arresting effect results for the locking latch 14 in the two end positions.

A securing lever 19 is furthermore mounted in the housing 13 of the lock 12 so as to be pivotable about a pivot pin 22. On its end that faces the locking latch 14, the securing lever 19 is provided with a blocking nose 20, while at its opposite end, relative to the pivot pin 22, the securing lever 19 is provided with an actuating tip 21. A spring 23 that is supported against the housing engages in the region of the actuating tip 21. The spring 23 biases the securing lever 19 into its blocking position for the locking latch 14, in which the blocking nose 20 is in engagement with a blocking recess 28 that is provided on the outer surface of the locking latch 14. Furthermore, associated with the actuating tip 21 is an electromagnet 24 that when current flows through it draws the actuating tip 21 to itself and thereby pivots the securing lever 19 against the effect of the spring 23 into a release position for the locking latch 14.

In addition, a microswitch 25 is disposed in the housing 13 in such a way that the microswitch 25 is actuated by an eccentric extension 30 disposed on the locking latch 14, in the opening position of the locking latch. The microswitch 25 is connected via an electrical lead 26 with a plug 27 disposed externally of the housing, so that the signal that is given off by the microswitch 25 when it is switched on can be read at the plug 27.

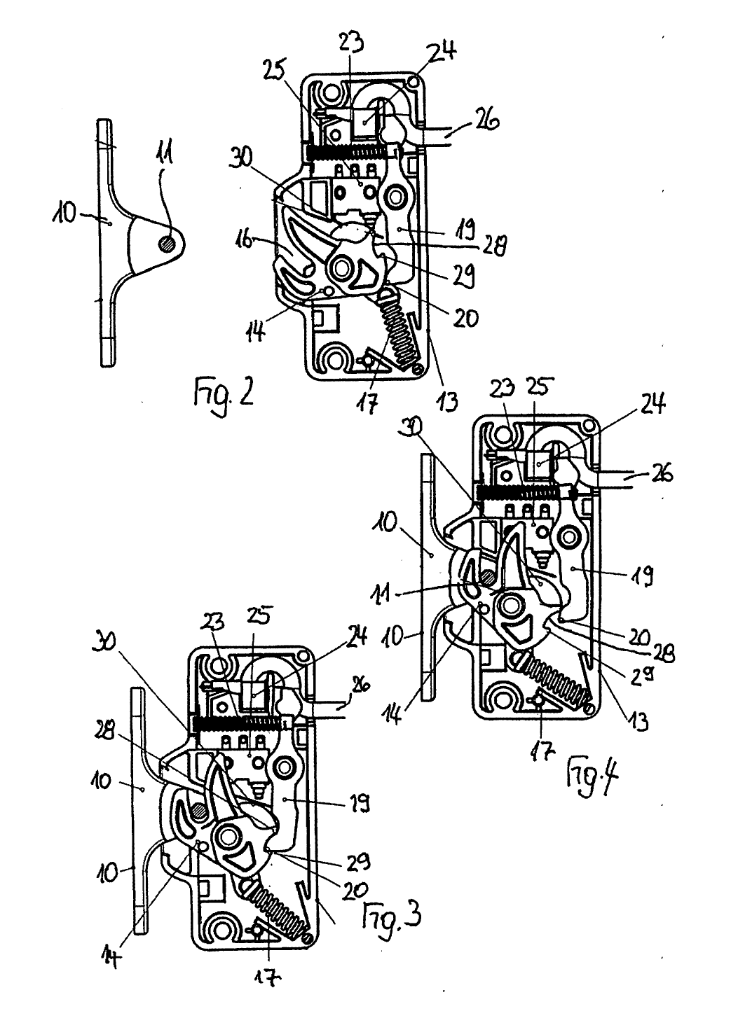

In the functional position illustrated in FIG. 2, the locking latch 14 is its opening position, in which the open side of its receiving opening 16 faces the lock holder 10 with its arresting pin 11. In this position, the locking latch 14 is held by the tipping spring 17. At the same time, the eccentric extension 30 actuates the microswitch 25, so that a signal can be read at the plug 27 indicating that the locking latch 14 is in the opening position, so that the door, with the lock holder secured thereto, can be closed. This can, for example, occur by the indication of a green lamp.

If the door is now closed by bringing the lock holder 10 to the lock 12, the arresting pin 11 engages into the receiving opening 16 of the locking latch 14. Since the corresponding contact surface of the receiving opening 16 is embodied in such a way that the arresting pin 11 that presses upon this surface acts upon the locking latch 14 in its closure position illustrated in FIG. 3, the locking latch 14 pivots into the position illustrated in FIG. 3, whereby this pivoting is assisted by the shifting of the tipping spring 17 from the one end position into the end position illustrated in FIG. 3 in which the tipping spring 17 holds the locking latch 14 in the closure position in an arresting manner. During this movement, the blocking nose 20 of the securing lever 19 slides along the outer surface of the locking latch 14 and catches or engages in the blocking recess 28 of the locking latch 14 under the pressure of the spring 23. In the blocking recess 28, the blocking nose 20 rests against the shoulder 29 that delimits the blocking recess 28, and prevents a reversing of the locking latch 14, even upon an appropriate pulling against the lock holder 10. In this position, the lock 12 is reliably latched with the lock holder 10. An opening is not possible.

If the locking device is open, current flows through the electromagnet 24, which thereby pivots the securing lever 19 into the position illustrated in FIG. 4 in which the blocking nose 20 now slides out of the blocking recess 28 to such an extent that upon pivoting of the locking latch 14 into the opening position (FIG. 2), the shoulder 29 can pass by the blocking nose 20 of the securing lever 19. Thus, when the electromagnet 24 is supplied with current, initially only an opening readiness of the locking latch 14 is provided in which it requires a pulling on the lock holder 10, or on the door that carries it, in order to now pivot the locking latch 14, against the force of the tipping spring 17, into its opening position shown in FIG. 2.

The features of the subject matter disclosed in the preceding description, the claims and the drawings can be important individually as well as in any desired combination with one another for realizing the various embodiments of the invention.

The specification incorporates by reference the disclosure of German priority document DE 20 2006 015 093.5 filed 30 Sep. 2006.

The present invention is, of course, in no way restricted to the specific disclosure of the specification and drawings, but also encompasses any modifications within the scope of the appended claims.

What I claim is:

1. A locking device, comprising;
a lock adapted to be mounted on a cabinet body, wherein said lock is provided with a pivotably mounted locking latch;
a lock holder adapted to be mounted on a cabinet door, wherein said lock holder is provided with an arresting pin that is adapted to latch with said locking latch;
a tipping spring for biasing said locking latch not only in an opening position thereof but also in a locking position in which said locking latch engages said arresting pin;
a pivotable securing lever for blocking pivoting movement of said locking latch;
a spring for biasing said securing lever into a position in which said securing lever blocks said locking latch; and
an electromagnet adapted to have current flow therethrough for providing a readiness of said locking latch to open, wherein said securing lever is adapted to be pivoted by said electromagnet, against the force of said spring, into a position for release of said locking latch.

2. A locking device according to claim 1, which further includes a microswitch disposed in said lock, wherein said microswitch is associated with said locking latch for generating a signal.

3. A locking device according to claim 2, wherein said microswitch is adapted to be actuated by said locking latch in the opening position of said locking latch.

4. A locking device according to claim 1, wherein said securing lever, in its blocking position, is adapted to rest against a shoulder disposed on an outer surface of said locking latch.

5. A locking device according to claim 1, wherein a receiving opening is formed in said locking latch for said arresting pin, and wherein an inner surface of said receiving opening cooperates with said arresting pin and is embodied in such a way that a pivoting of said locking latch into its locking position is adapted to be effected via pressure exerted upon said lock holder having said arresting pin, and that a pivoting of said locking latch into its opening position is adapted to be effected by a pulling exerted upon said lock holder having said arresting pin.
